(19) United States
(12) Patent Application Publication
(10) Pub. No.: US 2006/0271520 A1
(43) Pub. Date: Nov. 30, 2006

(54) Content-based implicit search query

(76) Inventor: Gene Zyrl Ragan, Santa Clara, CA (US)

Correspondence Address: FISH & RICHARDSON P.C., PO BOX 1022, MINNEAPOLIS, MN, 55440-1022, US

(21) Appl. No.: 11/139,131

(22) Filed: May 27, 2005

(51) Int. Cl. G06F 17/30

(52) U.S. Cl. 707/3

(57) ABSTRACT

Methods, systems, computer program products, and means for a provided for implicit searching. A method includes determining a context associated with a user interaction with a device; generating implicit search terms based on the context; searching a database using the implicit search terms to produce search results; and outputting the search results. The user interaction can be associated with an application such as a messaging application, word processing application, or an Internet browser. The output search results can be sourced from personal information saved by the application and associated with a user.

### BACKGROUND

The following disclosure generally relates to computing systems.

A user of a device such as a personal computer can launch individual software applications and store personal information using, for example, one or more of the individual software applications. The software applications, although typically in communication with a common operating system and a common hard drive, typically operate and store user information independently of each other. Additional information can be stored external to the device such as on web sites and private databases.

One store of personal information results from an e-mail application. A conventional e-mail application typically saves e-mails sent and received by a user in a local database. A user involved in a chat session with a remote user such as a customer may need to refer to previous e-mails sent to or received from the customer. To do so, the user can open up the e-mail application and use a search bar that may be specifically designed for the e-mail application to locate desired data (e.g., previously sent or received e-mail messages). The user can browse through a general listing of e-mails or enter explicit search terms to isolate e-mails related to the explicit search terms.

A conventional search engine can search one or more databases and return information that is related to explicit search terms. A user searching for information typically chooses search terms related to the desired information. For example, a user desiring to locate additional information about a subject can open up an Internet browser, navigate to a search engine web site, and choose search terms related to the subject. The search results, although related to the search terms, would typically be identical for any user inputting the same search terms.

### SUMMARY

This disclosure generally describes systems, methods, computer program products, and means for implicit searching of information stores. A proposed system can provide personal search results for a user based on interactions with a device (e.g., a personal computer). The proposed system can automatically display the personal search results in a non-intrusive manner for retrieval by a user on an as-needed basis (e.g., as the user notices relevant information). Furthermore, the proposed system can organize and display results corresponding to a current context (e.g., according to local information or local preferences).

In general, in one aspect, a method is provided. The method includes determining a context associated with a user interaction with a device; generating implicit search terms based on the context; searching a database using the implicit search terms to produce search results; and outputting the search results.

Some implementations can include one or more of the following features. Determining the context can include traversing from a first state to a second state responsive to one or more user interactions. The user interaction can include one or more of initializing an application, providing content to the application, receiving content in the application, selecting an object, or terminating the application. The method can further comprise monitoring an application to capture the user interaction. The user interaction can relate to a text string associated with an application, the application including one or more of a document, a web page, a spread sheet, or a message.

Generating the implicit search terms can include determining a subject matter from a text string. Generating the implicit search terms can include determining the context from a text string following one or more events. Generating the implicit search terms can include retrieving the implicit search terms from a predicted next state responsive to statistical information associated with a current state. The method can further include mapping the implicit search terms into database-specific commands. The database can be associated with an application associated with the device.

The method can further include ranking the search results according to relevance to the context. The method can further include ranking the search results based on a history associated with a user. The method can further include sorting the search results into categories. The method can further include organizing the search results based on one or more of user preferences, group preferences, or application-based preferences. The method can further include generating a results thread for each set of search results corresponding to an application.

In general, in another aspect, a method is provided including determining a user interaction associated with a device; generating implicit search terms based on one or more user interactions; searching a database using the implicit search terms to produce search results; and outputting the search results. The user interaction can include one or more of initializing an application, inputting content in the application, receiving content in the application, selecting an object, or terminating the application.

In general, in another aspect, a method is provided including determining a user interaction associated with a device; generating implicit search terms based on one or more user interactions; searching one or more local databases associated with one or more applications on the device using the implicit search terms to produce personalized search results; and outputting the personalized search results.

Some implementations can include one or more of the following features. Generating implicit search terms can include storing historical data related to the one or more user interactions; and generating the implicit search terms based on the historical data. Generating implicit search terms can include storing frequency data related to the one or more user interactions; and generating the implicit search terms based on the frequency data. Generating implicit search terms can include receiving personal settings from a user of the device; and generating the implicit search terms based on the personalized settings. The one or more local databases can include a plurality of messages stored on the device, the plurality of messages associated with a user causing the user interaction. The one or more applications can include one or more of an instant messenger application, an e-mail application, or an SMS application.

In general, in another aspect, a method is provided, including receiving content in a messaging application; generating implicit search terms based on the received content; searching one or more local databases associated with one or more applications on a device using the implicit search terms to produce personalized search results; and outputting the personalized search results.

Some implementations can include one or more of the following features. The one or more applications can be an application other than the messaging application. The one or more local databases associated with the one or more applications can include applications other than the messaging application.

In general, in another aspect, a method is provided, including receiving content in an Internet browser application; generating implicit search terms based on the received content; searching one or more databases associated with one or more applications on a device executing the Internet browsing application, including using the implicit search terms to produce personalized search results; and outputting the personalized search results.

Some implementations can include one or more of the following features. The one or more implementations can be an application other than the Internet browsing application. At least one of the one or more databases can be a local database. The one or more databases can include one or more of an Internet browsing cache, an Internet web site browsing history, Internet bookmarks, an Internet search results history or HTML documents.

In general, in another aspect, a method is provided, including determining a context associated with a user interaction with a device; inferring search terms based on the context, including retrieving search terms associated with a predicted next state of user interaction based on a current state of user interaction; searching a database using the search terms to produce search results; and outputting the search results

In general, in another aspect, a computer program product including instructions tangibly stored on a computer-readable medium is provided, the product including instructions for determining a context associated with a user interaction with a device; instructions for generating implicit search terms based on the context; instructions for searching a database using the implicit search terms to produce search results; and instructions for outputting the search results.

Some implementations can include one or more of the following features. The user interaction can relate to a text string associated with an application, the application including one or more of a document, a web page, a spread sheet, or a message. Generating the implicit search terms can include determining a subject matter from a text string.

In general, in another aspect, a system is provided, including a context engine to determine a context associated with user interaction with a device; a semantic analysis engine, in communication with the context engine, to generate implicit search terms based on the context; a query interface, in communication with the semantic analysis engine, to search a database using the implicit search terms and produce search results; and an output block, in communication to receive the search results, to output the search results. The system can include one or more of a personal computer, a laptop computer, a PDA, a multimedia player, a network device, and a cellular telephone.

The details of one these and other implementations are set forth in the accompanying drawings and description below.

### DESCRIPTION OF DRAWINGS

FIG. 1 is a block diagram illustrating a proposed system for implicit querying.

FIG. 2 is a schematic diagram illustrating an implicit query block of the proposed system of FIG. 1.

FIG. 3 is a flow diagram illustrating a method for implicit querying.

FIG. 4 is a schematic diagram illustrating an example of a first user interface of a search results window.

FIG. 5 is a schematic diagram illustrating an example of a second user interface of a search results window.

FIG. 6 is a schematic diagram illustrating an example of a third user interface of a search results window.

### DETAILED DESCRIPTION

Systems, methods, computer program products, and means for implicit or inferential querying (e.g., based on a user interaction or a user context) are described. In general, search results having some relevance to user interactions, such as personal information of a user, can be automatically generated and displayed on a user interface. As used herein, context refers to a user experience (e.g., current, past or inferred experience) with a device including interactions with software applications (e.g., type of application, activated function within an application), hardware (e.g., state of a device), and displayed information (e.g., text strings or graphics). Context can be determined from direct or indirect user interactions such as text strings and other content being displayed by an application (e.g., web content received responsive to navigating to a web page, a message received responsive to launching a messaging application, etc.), text strings input by a user, text strings sent to a user, one or more events caused by a user (e.g., using selectable icons), states of an application, and the like. Context information, as used herein, refers to information relating to a state of a device.

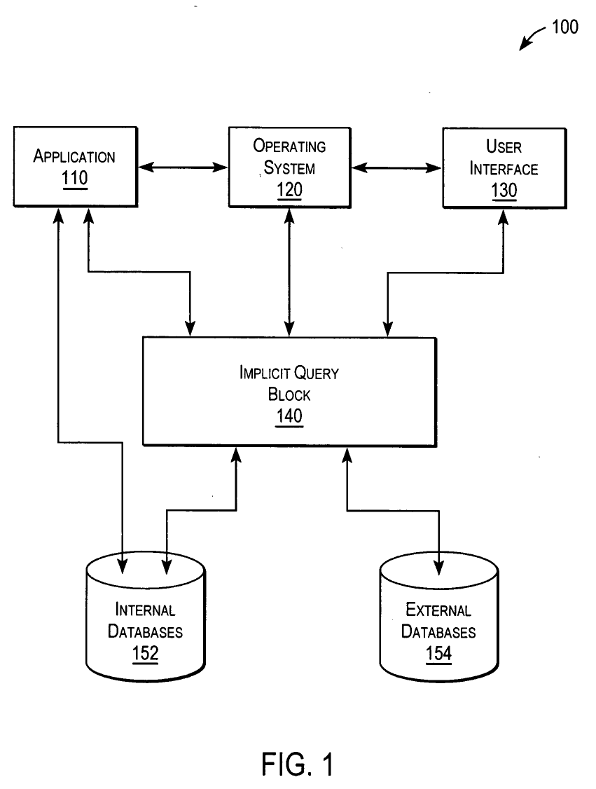

FIG. 1 is a block diagram illustrating a system 100 for implicit querying of one or more databases. System 100 includes one or more applications such as application 110, an operating system 120, a user interface 130, an implicit query block 140, and internal and external databases 152, 154.

Application 110 receives user input through an input device (not shown) such as a mouse, touch screen, telephone keypad, keyboard, and the like. Application 110 produces context information (e.g., associated with user input or application or device state) to implicit query block 140. Application 110 can be, for example, a software program such as a word processing application, an Internet browser, a spreadsheet application, a video game, an e-mail application, an instant messaging or chat application, a multimedia application, and the like, displayed in user interface 130. In some implementations, application 110 includes fields to receive and/or display text strings or other input from a local user, a remote user in communication with the local user, or a database. Application 110 can also include graphical elements selectable by a user (e.g., buttons or hyperlinks) which can change a context of application 110 (e.g., change from reading an e-mail to replying to an e-mail). Application 110 can enter different states such as initializing, active, background, sleep or terminating. In one implementation, application 110 includes a plug-in or daemon associated with implicit query block 140 to, for example, gather context information or display implicit query results in an integrated panel or window.

Operating system 120 is in communication with application 110 and user interface 130. Operating system 120 can also send context information to implicit query block 140. Operating system 120 can be, for example, a MAC OS X operating system by Apple Computer, Inc. of Cupertino, Calif. a Microsoft Windows operating system, a mobile operating system, control software, and the like. In some implementations, a portion or all of implicit query block 140 is integrated within operating system 120. In other implementations, implicit query block 140 interrogates operating system 120 to identify and provide context information to implicit query block 140 related to user interactions with operating system 120, states of applications such as application 110, states of user interface 130, and the like. For example, operating system 120 can inform implicit query block 140 that a user has minimized one window displaying an application and maximized another window displaying a different application. Alternatively, operating system 120 can produce context information without a specific query.

More generally, a kernel layer (not shown) in operating system 120 can be responsible for general management of system resources and processing time. A core layer can provide a set of interfaces, programs and services for use by the kernel layer. A user interface layer can include APIs (Application Program Interfaces), services and programs to support user applications. One or more of the layers can provide context information to implicit query block 140.

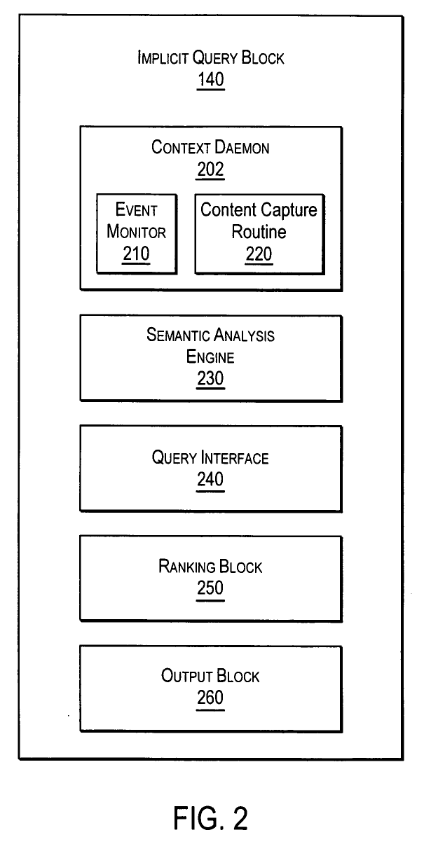

Implicit query block 140 receives context information as described. Implicit query block 140 is also in communication with internal and external database 152, 154 for providing search terms and receiving search results. Implicit query block 140 can be, for example, a software program, a plug-in, a daemon, or a process and include one or more engines for context, analysis and presentation functions as discussed below in association with FIG. 2. In one implementation, implicit query block 140 can be executed on a dedicated software thread or a dedicated hardware thread. Implicit query block 140 can be initiated at boot-up, explicitly by a user, or responsive to launching a registered application (e.g., application 110). In general, implicit query block 140 provides information (e.g., local or personal information) to a user that is related to a context and user interactions (e.g., current or historical user interactions) associated with the user. For example, when a user is chatting with a certain person, implicit query block 140 can retrieve and display contact information or e-mails associated with that person. In another example, when a user opens an e-mail about a certain subject matter, implicit query block 140 can identify and display links to web pages associated with that subject matter. Further details in association with implicit query block 140 are given below.

Internal databases 152 can include locally available information from metadata and/or files associated with application 110 (e.g., e-mails, Internet bookmarks, Internet browsing history), a company intranet, a log file, a file structure, a system folder, cache files, recent documents, and the like. In some implementations, internal databases 152 are already sorted (e.g., extracted or indexed) for easy searching, such as a telephone book associated with a dialer application, a list of songs associated with a media player, or a document that has been analyzed for context. In one implementation, an indexer such as Matador (Multilingual Testbed for Document Retrieval) available in MAC OS X is used to gather information across applications. In other implementations, internal databases 152 contain raw data such as text files, e-mails, data files, and the like. In another implementation, internal databases 152 can store locally available information about user interactions with external databases 154. For example, internal databases 152 can include an Internet browsing cache, an Internet web site browsing history, Internet bookmarks, an Internet search results history, HTML documents, and the like. In some implementations, the types of data in internal databases 152 are specifically related to a user (e.g., created, saved or modified by a user, addressed to a user, user preferences for a particular application, frequency information such as number of times an MP3 file is played, etc.).

External databases 154 can include information from sources such as the Internet (e.g., from search engines, auction sites, online book stores, content producers, etc.), private or subscription databases, a remote user or machine, and the like. As with internal databases 152, information can be presorted or raw. In some implementations, an intermediary to external databases 154 such as a public search engine can be used for access (e.g., search engine returning results for an auction web site) to the underlying data.

FIG. 2 is a more detailed block diagram illustrating implicit query block 140. Implicit query block 140 includes a context engine 202, a semantic analysis engine 230, a query interface 240, a ranking block 250 and an output block 260. Context engine 202 further comprises an event monitor 210 and a content capture routine 220.

Context engine 202 can be, for example, an application program or a module of an application program, a plug-in, a daemon, a script, or a process. In some implementations, context engine 202 is integrated within operating system 120. In some implementations, context engine 202 operates as a separate application program. In general, context engine 202 receives (or captures through interrogation) the context information. Event monitor 210 can receive information describing user interactions and states of applications. User interactions can include operations resulting from mouse clicks, launching or terminating an application, and the like. Content capture routine 220 can receive text strings or other content being displayed. The text strings can be, for example, part of a message being viewed (e.g., e-mail, SMS, instant message, etc.), a message being created, an incoming message, a web page, and the like.

Semantic analysis engine 230 analyzes incoming event information and content (e.g., text strings) in order to generate related search terms. Based on context information from events and/or content, semantic analysis engine 230 determines a context of a user in order to identify personal information that is relevant to current user interactions with a device. In one implementation, semantic analysis engine 230 parses text strings into components used for search terms. Semantic engine 230 can use relationships between the components to identify phrases, subject matter, and otherwise abstract the components into search terms. In another implementation, semantic analysis engine 230 analyzes text strings with respect to a particular application (e.g., using application-specific libraries). Semantic analysis engine 230 can use, for example, a Hidden Markov Model to perform a statistical analysis on components. In general, a Hidden Markov Model provides probabilities of moving to a future state based on a current state. In relation to component events and content, semantic analysis engine 230 can predict useful words for search terms based on a current word (or current application state, user interaction, etc.). In one implementation, semantic analysis engine 230 uses gathered statistical information associated with a user and relating to frequency, history, ratings, preference settings, and the like, to generate search terms.

Query interface 240 uses search terms (e.g., implicit or inferential search terms) derived by semantic analysis engine 230 to request search results from databases. In one implementation, query interface 240 can use APIs or other database-specific semantics (e.g., SQL commands) for communication with other search engines or directly with databases. Various resources for information can be preset, input through a user interface, or discovered by query interface 240 (e.g., when a new application or hard drive/flash drive is installed). Query interface 240 can also manage access to software and/or hardware communication ports. In some implementations, query interface 240 may request permissions for accessing certain software or request passwords for accessing certain databases.

Ranking block 250 receives and organizes search results. In one implementation, results are separated by source such as Internet search results, e-mail, contacts, applications, and the like. In another implementation, results are separated by search terms used to generated listed results. Ranking block 250 can further organize results by age, relevance scores, and other user preferences. Ranking block 250 can also use privacy settings or other blocks to exclude ranking results.

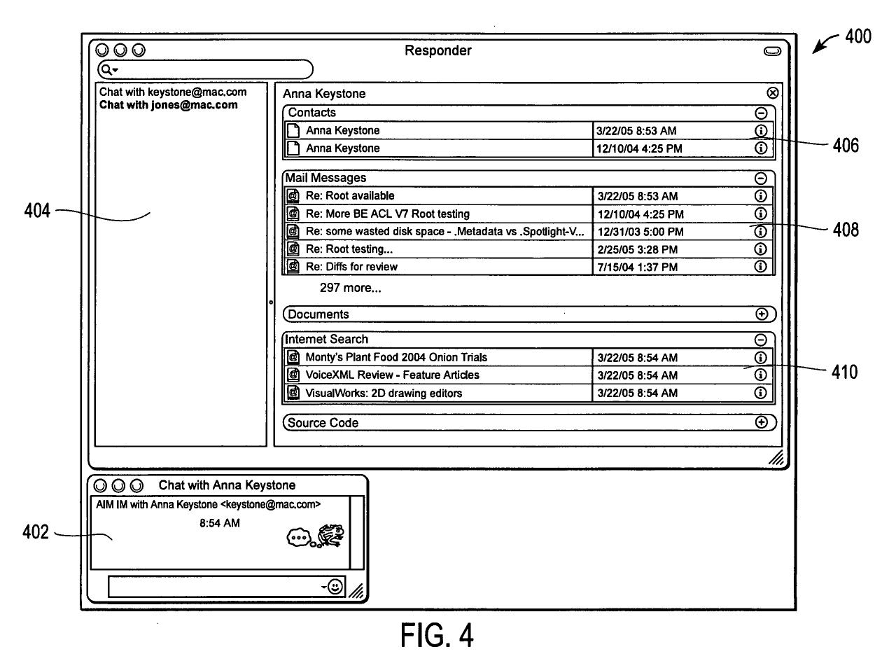

Output block 260 sends information to user interface 130 (FIG. 1) for displaying implicit search results. Output block 260 can produce various panels for display such as a results panel to display implicit query results, a thread panel to display different instances of results (e.g., each thread relating to search results for an application or an instance of an application), a search terms panel to show implicit search terms used to produce results, and the like (see examples shown in FIGS. 4-6). Output block 260 can request a new window or a new thread within an existing window.

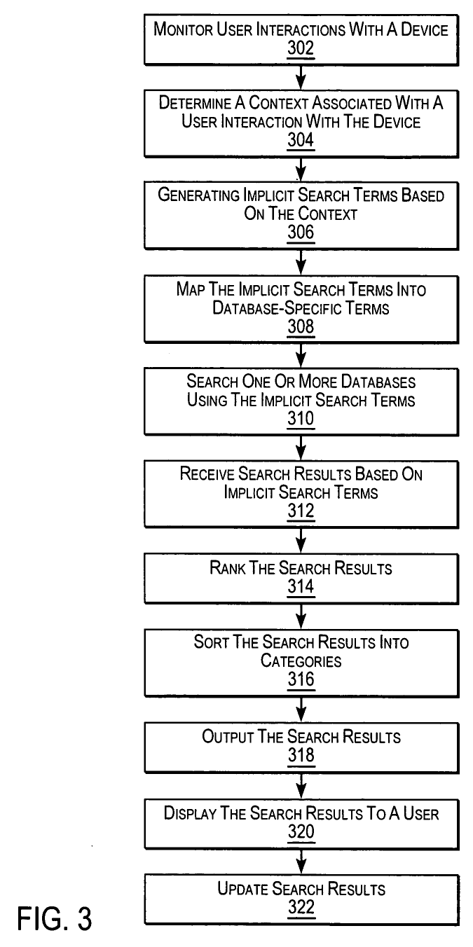

FIG. 3 is a flow diagram illustrating a method 300 for implicit querying. User interactions with a device are monitored 302 (e.g., in application 110 or operating system 120 by context engine 202). In an application having an integrated context engine, context information can be gathered for analysis directly from an application. In an application having a separate context engine, context information can be non-intrusively observed by, for example, intercepting messages to an operating system or tracking mouse actions that are mapped to operations within the application.

In one implementation, user-generated events such as a mouse click or application launch are monitored (e.g., by event monitor 210). A sequence of events can be tracked with a state machine. For example, a multimedia application can be launched and a specific multimedia file can be selected for playback. In another implementation, text strings being displayed are monitored (e.g., by content capture routine 220). For example, rather than being played back, a user can navigate to a web page containing a review about the multimedia file.

A context associated with a user interaction with the device is determined 304. Context refers to a user experience (e.g., current, past or inferred experience) with a device including interactions with software applications (e.g., type of application, activated function within an application), hardware (e.g., state of a device), and displayed information (e.g., text strings or graphics). Context can be determined from direct or indirect user interactions such as text strings and other content being displayed by an application (e.g., web content received responsive to navigating to a web page, a message received responsive to launching a messaging application, etc.), text strings input by a user, text strings sent to a user, one or more events caused by a user (e.g., using selectable icons), states of an application, and the like. Context information, as used herein, refers to information relating to a state of a device. The context can be based on one or more current or past events, displayed content, or a combination of the two. A user in the context of playing a multimedia file will likely be interested in search results that are different from a user in the context of viewing web content about the same multimedia file. In a multimedia playback, context information can produce search results including an album cover, lyrics, credits, or other information associated with multimedia playback. In a multimedia-related web page navigation, however, context information may take a different form to produce search results including reviews, news articles, an artist web page, and other research associated with the multimedia file.

Search terms based on the context are generated 306 (e.g., by semantic analysis engine 230). In one implementation, a Hidden Markov Model is used to predict relevant search terms. In some implementations, the search terms can be the same as context information (e.g., text) received. In another implementation, the search terms are abstracted from components of context information. For example, a search term can correspond to a subject matter abstracted from a sentence or paragraph forming a text string, and a multimedia file can be categorized into a genre based on an associated metadata tag. In another example, a paragraph including computer terms and including the term “Tiger” can be abstracted to the implicit search query “Tiger AND operating system NOT animal.”

The search terms are optionally mapped into database-specific terms 308 (e.g., by query interface 240). For example, implicit search terms can be expressed in several different formats based on APIs provided by major search engines (e.g., Google, Amazon, or eBay APIs), semantics used by databases (e.g., a SQL-based database), or an XML format.

One or more databases are searched using the implicit search terms 310 (e.g., internal and external databases 152, 154). The databases can be searched directly or indirectly using, for example, a third-party search engine. In one implementation, databases are registered with a query interface either manually, automatically during installation, or responsive to being discovered by the query interface. In some implementations, local files are indexed by the query interface or an independent application such as Matador for quicker searching.

Search results based on the search terms are received 312 (e.g., by ranking block 250). The search results are ranked 314 according to predetermined criteria (e.g., relevancy to a user or relevancy in accordance with user preferences). For example, when a chat application sources context information, logs associated with that chat application can be more relevant. Search results are optionally sorted into categories 316. The categories can be based on databases, applications, implicit search terms, source, preferences, and the like as shown below in FIGS. 4-6. In one implementation, a new thread is created for search results associated with a particular application, or instance of the particular application. For example, a new thread can be created for each conversation corresponding to different instances of an instant messenger.

The search results are output 318 (e.g., by output block 260 to user interface 130) and displayed to a user 320 in the user interface. In one implementation, a notification of new or updated results can be output, such as a temporary window, a flashing icon in a task bar, a beep, a speech engine output, and the like. In a results window, particularly relevant search results can be emphasized with, for example, icons or sounds. Previews can be provided for an article or graphic file. Search results can be linked to the underlying source material using shortcuts, pointers, hyperlinks, buttons, and the like. In one implementation, a separate window is used for display. In another implementation, a results widow is integrated into an application. The results window can use settings to control behavior such a time out setting to minimize or close the results window after a predetermined amount of time, a number of results settings to control how many results are displayed, or an enable/disable setting to turn the results window on and off.

Search results are updated 322 either on-the-fly for better responsiveness or periodically for lower resource usage. The updates can be made sequentially to include the latest search results or contextually to correspond to an active application.

Local preferences can have a direct role in the steps of method 300, in some implementations, to produce more personalized results. More specifically, preferred applications, types of data, user habits, and other personal information associated with a particular use. In some implementations, local preferences associated with a user can affect search results. The local preferences can, on a user specific basis, determine or influence which implicit search terms are produced in response to user interactions. Moreover, local preferences can affect how search results are ranked, organized and output.

A user can be identified with associated preferences by, for example, a log-in associated with the operating system, a log-in associated with one of the applications, a recognition system (e.g., fingerprint, voice, or identification card). In some embodiments, local preferences are associated with a type of device or a type of application. For example, a telephone is likely to execute applications such as a dialer application, a phone book application, and an SMS application. On the other hand, a telephone is not likely to execute a spread sheet application or a Java development application. In some implementations, local preferences are associated with a group of users (e.g., students, software programmers, etc.).

Local preferences can be set-up using various techniques. In some implementations, an automated set-up dialogue (e.g., a set-up wizard) can be used to collect data for settings for non-advanced users. Advanced users can manipulate settings directly using drop-down menus, settings tabs, macros, and the like. In some implementations, local preferences can be predicted using empirical data about a user as training data. Empirical data can include frequency statistics, history, similar preferences, and the like. For example, contacts can be listed first in a results window for a user that primarily or exclusively makes use of contact search results. In another example, more relevancy can be given to web results related to country music where a user has a majority of music files categorized in the country genre. In another example, a user can rate search results from which empirical data can be abstracted.

In some implementations, search results generated from local preferences can be augmented by other factors. For example, random search results (e.g., search results generated without local preferences) can be output to prevent over-training or increasingly-narrow search results. In another example, advertisements are included in search results.

FIG. 4 is a schematic diagram illustrating a first user interface 400. A chat application 402 (instant messenger, SMS, e-mail, etc.) has initiated a session with a remote user, Anna Keystone. A thread panel 404 separates search results associated with the active chat session from parallel or historical chat sessions (i.e., with remote user, jones).

In this implementation, search results are organized by file type. A contacts tab 406 includes two different contact records for the remote user (e.g., an e-mail address record and a telephone book record). A mail messages tab 408 includes mail messages to, from, or making mention of the remote user. An Internet search tab 410 includes web results that are potentially associated with the remote user.

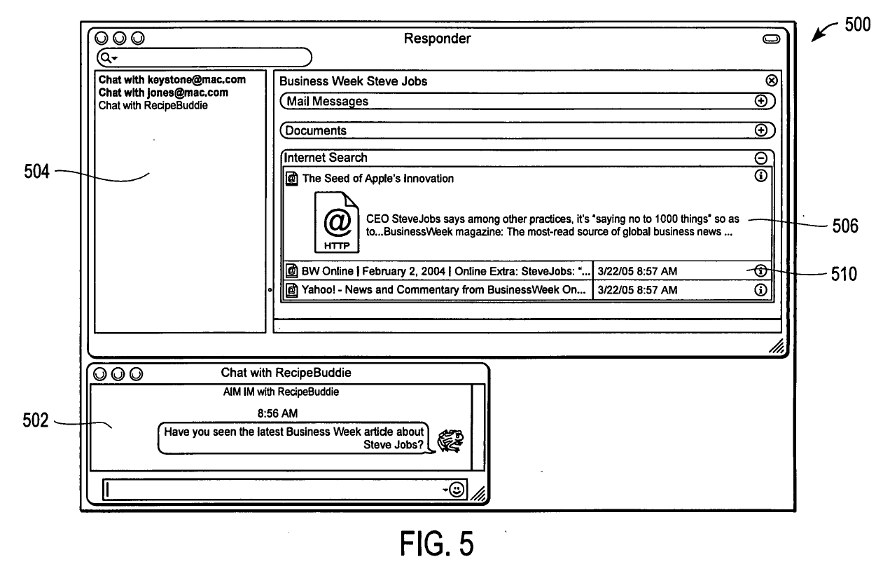

FIG. 5 is a schematic diagram illustrating a second user interface 500. A chat application 502 has been initiated and includes a message from a remote user, RecipeBuddie. A thread panel 504 has added a thread corresponding to the active chat session. An Internet search tab 506 displays search results associated with the message. More specifically, implicit search terms abstracted from the text string including the subject matter “Steve Jobs” and “Business Week” returned a web page including the article referred to by the remote user. The article, having a high relevance score, is emphasized in the Internet search tab 506. Additional, but less relevant, search results include commentary 510 about the article.

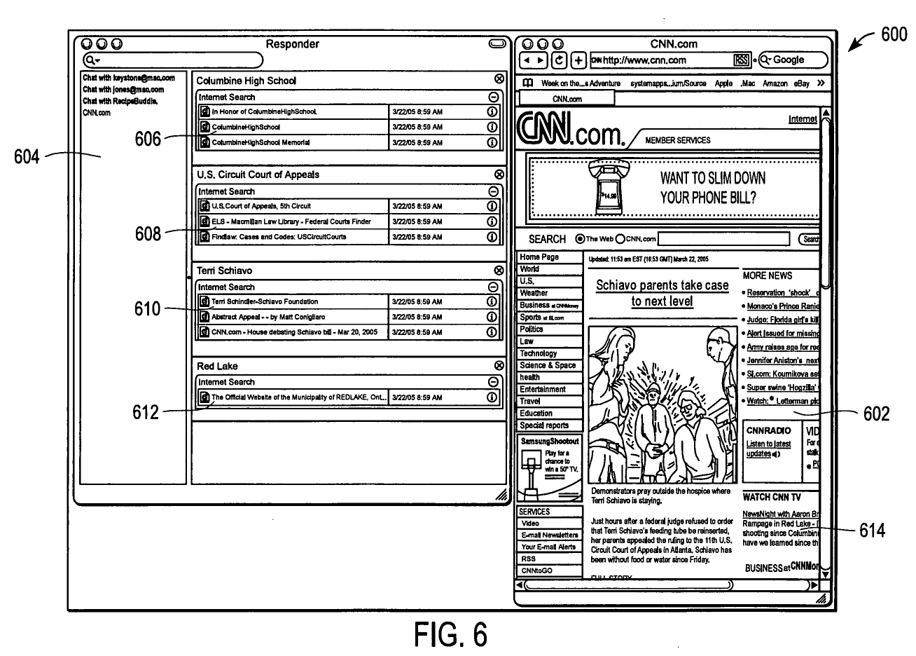

FIG. 6 is a schematic diagram illustrating a third user interface 600. An Internet browser 602 has been initiated and includes web page content from CNN.com. A thread panel 604 includes a thread corresponding to the active web session.

Implicit search terms are generated to search databases and search results are organized by implicit search terms. Results output include a first Internet search panel 606 includes web pages related to Columbine High School since the web page content refers to the same (see reference 614). Similarly, a second, third, and fourth search panels 608,610, and 612 include web pages related to implicit search terms derived from the web page content.

The invention and all of the functional operations described herein can be implemented in digital electronic circuitry, or in computer hardware, firmware, software, or in combinations of them. The invention can be implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the invention can be performed by one or more programmable processors executing a computer program to perform functions of the invention by operating on input data and generating output. Method steps can also be performed by, and apparatus of the invention can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in special purpose logic circuitry.

To provide for interaction with a user, the invention can be implemented on a device having a display, e.g., a CRT (cathode ray tube) or LCD (liquid crystal display) monitor, for displaying information to the user and an input device, e.g., a keyboard, a mouse, a trackball, and the like by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

The invention can be implemented in, e.g., a personal or laptop computing system, a handheld device (e.g., a PDA), a telephone (e.g., cellular or computer-based), a consumer appliance, a multimedia player or any other processor-based device. A computing system implementation can include a back-end component, e.g., as a data server, or that includes a middleware component, e.g., an application server, or that includes a front-end component, e.g., a client computer having a graphical user interface or a Web browser through which a user can interact with an implementation of the invention, or any combination of such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

A number of implementations have been described. Nevertheless, it will be understood that various modifications may be made. For example the first and second sets of keys can be one or two keys. In addition to keys, users can enable a mouse, a thumbwheel, or other input device to make adjustments. Accordingly, other implementations are within the scope of the following claims.

What is claimed is:

1. A method, including:
determining a context associated with a user interaction with a device;
generating implicit search terms based on the context;
searching a database using the implicit search terms to produce search results; and
outputting the search results.

2. The method of claim 1, wherein determining the context includes: traversing from a first state to a second state responsive to one or more user interactions.

3. The method of claim 1, wherein the user interaction includes one or more of initializing an application, providing content to the application, receiving content in the application, selecting an object, or terminating the application.

4. The method of claim 1, further comprising:
monitoring an application to capture the user interaction.

5. The method of claim 1, wherein the user interaction relates to a text string associated with an application, the application including one or more of a document, a web page, a spread sheet, or a message.

6. The method of claim 1, wherein generating the implicit search terms includes:
determining a subject matter from a text string.

7. The method of claim 1, wherein generating the implicit search terms includes:
determining the context from a text string following one or more events.

8. The method of claim 1, wherein generating the implicit search terms includes:
retrieving the implicit search terms from a predicted next state responsive to statistical information associated with a current state.

9. The method of claim 1, further including:
mapping the implicit search terms into database-specific commands.

10. The method of claim 1, wherein the database is associated with an application associated with the device.

11. The method of claim 1, further including:
ranking the search results according to relevance to the context.

12. The method of claim 1, further including:
ranking the search results based on a history associated with a user.

13. The method of claim 1, further including:
sorting the search results into categories.

14. The method of claim 1, further including:
organizing the search results based on one or more of user preferences, group preferences, or application-based preferences.

15. The method of claim 1, further including:
generating a results thread for each set of search results corresponding to an application.

16. A method, including:
determining a user interaction associated with a device;
generating implicit search terms based on one or more user interactions;
searching a database using the implicit search terms to produce search results; and
outputting the search results.

17. The method of claim 16, wherein the user interaction includes one or more of initializing an application, inputting content in the application, receiving content in the application, selecting an object, or terminating the application.

18. A method, including:
determining a user interaction associated with a device;
generating implicit search terms based on one or more user interactions;
searching one or more local databases associated with one or more applications on the device using the implicit search terms to produce personalized search results; and
outputting the personalized search results.

19. The method of claim 18, wherein generating implicit search terms includes:
storing historical data related to the one or more user interactions; and
generating the implicit search terms based on the historical data.

20. The method of claim 18, wherein generating implicit search terms includes:
storing frequency data related to the one or more user interactions; and
generating the implicit search terms based on the frequency data.

21. The method of claim 18, wherein generating implicit search terms includes:
receiving personal settings from a user of the device; and
generating the implicit search terms based on the personalized settings.

22. The method of claim 18, wherein the one or more local databases include a plurality of messages stored on the device, the plurality of messages associated with a user causing the user interaction.

23. The method of claim 18, wherein the one or more applications include one or more of an instant messenger application, an e-mail application, or an SMS application.

24. A method executing on a device, including:
receiving content in a messaging application;
generating implicit search terms based on the received content;
searching one or more local databases associated with one or more applications on a device using the implicit search terms to produce personalized search results; and
outputting the personalized search results.

25. The method of claim 24, wherein the one or more applications includes an application other than the messaging application

26. The method of claim 24, wherein the one or more local databases associated with the one or more applications include applications other than the messaging application.

27. A method, including:
receiving content in an Internet browser application;
generating implicit search terms based on the received content;
searching one or more databases associated with one or more applications on a device executing the Internet browsing application, including using the implicit search terms to produce personalized search results; and
outputting the personalized search results.

28. The method of claim 27, wherein the one or more applications includes an application other than the Internet browsing application.

29. The method of claim 27, wherein at least one of the one or more databases is a local database.

30. The method of claim 27, wherein the one or more databases includes one or more of an Internet browsing cache, an Internet web site browsing history, Internet bookmarks, an Internet search results history or HTML documents.

31. A method, including:
determining a context associated with a user interaction with a device;
inferring search terms based on the context, including retrieving search terms associated with a predicted next state of user interaction based on a current state of user interaction;
searching a database using the search terms to produce search results; and
outputting the search results.

32. A computer program product including instructions tangibly stored on a computer-readable medium, the product including:
instructions for determining a context associated with a user interaction with a device;
instructions for generating implicit search terms based on the context;
instructions for searching a database using the implicit search terms to produce search results; and
instructions for outputting the search results.

33. The computer program product of claim 32, wherein the user interaction involves a text string associated with an application, the application including one or more of a document, a web page, a spread sheet, or a message.

34. The computer program product of claim 32, wherein generating the implicit search terms includes:
determining a subject matter from a text string

35. A system, including:
a context engine to determine a context associated with user interaction with a device;
a semantic analysis engine, in communication with the context engine, to generate implicit search terms based on the context;
a query interface, in communication with the semantic analysis engine, to search a database using the implicit search terms and produce search results; and
an output block, in communication to receive the search results, to output the search results.

36. The system of claim 35, wherein the system includes one or more of a personal computer, a laptop computer, a PDA, a multimedia player, a network device, and a cellular telephone.
